(19) United States
(12) Patent Application Publication
(10) Pub. No.: US 2020/0122959 A1
(43) Pub. Date: Apr. 23, 2020

(54) ELEVATOR OPERATION MANAGEMENT DEVICE, ELEVATOR OPERATION MANAGEMENT METHOD AND COMPUTER READABLE MEDIUM

(71) Applicant: Mitsubishi Electric Corporation, Tokyo (JP)

(72) Inventor: Takashi SAKAKURA, Tokyo (JP)

(73) Assignee: Mitsubishi Electric Corporation, Tokyo (JP)

(21) Appl. No.: 16/619,058

(22) PCT Filed: Jul. 12, 2017
(86) PCT No.: PCT/JP2017/025412

§ 371 Date: Dec. 3, 2019

(51) Int. Cl. B66B 1/24; B66B 11/02; B66B 1/34; B66B 3/00; B66B 1/46

(52) U.S. Cl. CPC B66B 1/2466; B66B 11/0226; B66B 1/2491; B66B 9/003; B66B 3/002; B66B 1/468; B66B 2201/30; B66B 1/3407

(57) ABSTRACT

An elevator operation management device (600) performs operation management of a plurality of elevator cars. A machine-learning unit (601) performs machine-learning using operation data which indicates an operation status of the plurality of elevator cars, and generates an operation management algorithm which is an algorithm used for operation management of the plurality of elevator cars. The control unit (602) executes the operation management algorithm generated by the machine-learning unit (601), and performs operation management of the plurality of elevator cars.

### TECHNICAL FIELD

The present invention relates to elevator operation management.

### BACKGROUND ART

In a building where a plurality of elevator cars are installed, such as a high-rise building or the like, the plurality of elevator cars are operated efficiently so as to shorten waiting time after a call.

As technologies related to elevator operation management, there are technologies disclosed in Patent Literature 1-4, for example.

### CITATION LIST

### Patent Literature

Patent Literature 1: JP2006-199394A

Patent Literature 2: JP2001-226048A

Patent Literature 3: JP07-309541A

Patent Literature 4: JP59-012594A

### SUMMARY OF INVENTION

### Technical Problem

Generally, when a new elevator is installed in a building on such an occasion of the building being newly built, an elevator installer generates an algorithm for elevator operation management, and implements the generated algorithm on an elevator operation management device.

More specifically, the elevator installer predicts an operation status of when the elevator actually operates, generates an algorithm which enables operation considered to be the most efficient at that time, and implements the generated algorithm on the elevator operation management device.

However, in this method, an algorithm which does not match an actual situation is executed if the operation status predicted when generating the algorithm differs from the actual operation status. Therefore, in this case, there is a problem that efficient elevator operation management is not performed.

Also, there is a case where the operation status predicted when generating the algorithm does not match the actual operation status for ex-post reasons. For example, a change on a tenant in a building may change a flow of elevator users. In such a case, the algorithm which does not match the actual operation status is executed, and thereby efficient elevator operation management is not performed.

The present invention mainly aims at solving such a problem. More specifically, it mainly aims at realizing a configuration which enables appropriate operation management of elevator cars by an operation management algorithm matching the actual operation status.

### Solution to Problem

An elevator operation management device performing operation management of a plurality of elevator cars according to the present invention, the elevator operation management device includes:

a machine-learning unit to perform machine-learning using operation data which indicates an operation status of the plurality of elevator cars, and generate an operation management algorithm which is an algorithm used for operation management of the plurality of elevator cars; and

a control unit to execute the operation management algorithm generated by the machine-learning unit, and perform operation management of the plurality of elevator cars.

### Advantageous Effects of Invention

In the present invention, an operation management algorithm is generated by machine-learning using operation data which indicates an operation status of a plurality of elevator cars. Then, the generated operation management algorithm is executed, and operation management of the plurality of elevator cars is performed. Therefore, according to the present invention, operation management of elevator cars can be performed appropriately by the operation management algorithm adapted to the actual operation status.

### BRIEF DESCRIPTION OF DRAWINGS

FIG. 1 is a diagram illustrating a configuration example of an elevator system according to Embodiment 1.

FIG. 2 is a diagram illustrating an example of positioning elevator cars according to Embodiment 1.

FIG. 3 is a diagram illustrating a hardware configuration example of an elevator operation management device according to Embodiment 1.

FIG. 4 is a diagram illustrating a functional configuration example of the elevator operation management device according to Embodiment 1.

FIG. 5 is a diagram illustrating an operational outline of a machine-learning unit according to Embodiment 1.

FIG. 6 is a flowchart illustrating an operational outline of the elevator operation management device according to Embodiment 1.

FIG. 7 is a flowchart illustrating a procedure of generating an operation management algorithm according to Embodiment 1.

FIG. 8 is a flowchart illustrating an operational procedure of the machine-learning unit according to Embodiment 1.

FIG. 9 is a flowchart illustrating an operational procedure of a data set adjustment unit according to Embodiment 1.

FIG. 10 is a flowchart illustrating a procedure of selecting a guiding elevator car according to Embodiment 1.

FIG. 11 is a flowchart illustrating a procedure of selecting the guiding elevator car according to Embodiment 1.

FIG. 12 is a diagram illustrating an example of a display of waiting time in a countdown form according to Embodiment 1.

FIG. 13 is a diagram illustrating an example of a display of waiting time in a sandglass form according to Embodiment 1.

FIG. 14 is a diagram illustrating an example of a hoistway according to Embodiment 2.

FIG. 15 is a diagram illustrating an example of an elevator car in a regular hoist lane and an elevator car in a forwarding hoist lane according to Embodiment 2.

FIG. 16 is a diagram illustrating an example of the elevator car in the regular hoist lane and the elevator car in the forwarding hoist lane.

FIG. 17 is a diagram illustrating details of a hinge mechanism according to Embodiment 2.

FIG. 18 is a diagram illustrating details of a latch according to Embodiment 2.

FIG. 19 is a diagram illustrating an intermediate process of when an elevator car is folded according to Embodiment 2.

FIG. 20 is a flowchart illustrating an operational procedure of a control unit according to Embodiment 2.

FIG. 21 is a flowchart illustrating an operational procedure of the control unit according to Embodiment 2.

FIG. 22 is a diagram illustrating an example of a control panel according to Embodiment 3.

FIG. 23 is a diagram illustrating an example of an operation screen of the control panel according to Embodiment 3.

FIG. 24 is a diagram illustrating an example of an operation screen of a smartphone according to Embodiment 4.

FIG. 25 is a diagram illustrating an example of an operation screen of the smartphone according to Embodiment 4.

### DESCRIPTION OF EMBODIMENTS

Embodiments of the present invention will be described below, using diagrams. In descriptions and diagrams in the embodiments below, elements provided with same reference signs indicate the same elements or corresponding elements.

### Embodiment 1

***Description of Configuration***

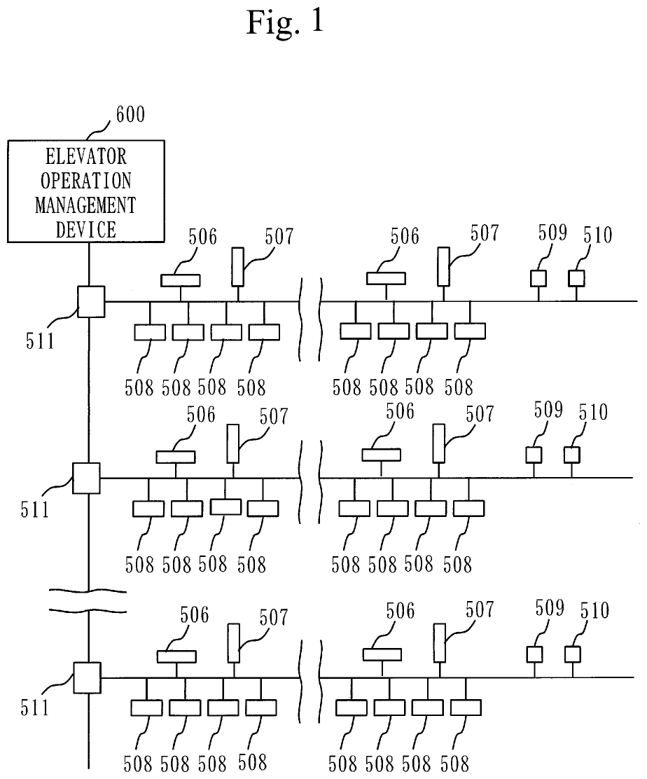

FIG. 1 illustrates a configuration example of an elevator system according to the present embodiment.

In the elevator system according to the present embodiment, a plurality of elevator cars (also called simply as “cars” hereinafter) is operated.

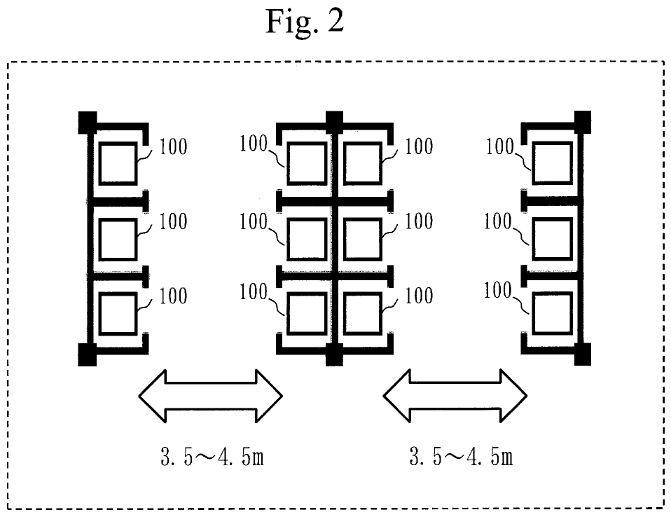

In the elevator system according to the present embodiment, the plurality of elevator cars is operated. The plurality of elevator cars is positioned as in FIG. 2, for example. FIG. 2 illustrates elevator halls of each floor from above. In the example of FIG. 2, 12 elevator cars 100 are positioned. Spaces for getting on and off the elevator cars 100 correspond to elevator halls. That is, 12 elevator halls exist in the example of FIG. 2.

An elevator operation management device 600 performs operation management of the plurality of elevator cars. The elevator operation management device 600 is a computer.

Operation performed by the elevator operation management device 600 corresponds to an elevator operation management method.

Details of the elevator operation management device 600 will be described later.

The elevator operation management device 600 is connected to a network switch 511 positioned on each floor. Also, a plurality of network switches 511 is cascade-connected.

On each floor, a display board 506 and a destination button 507 per elevator hall are connected to the network switch 511. The destination button 507 may be an up button and a down button, or may be a plurality of buttons covering all floors.

All control panels 508 of the elevator cars are also connected to the network switch 511.

In addition, a communication device 509 which communicates with the elevator operation management device 600 and a wireless LAN (Local Area Network) access point 510 are also connected to the network switch 511.

In the elevator system according to the present embodiment, TCP/IP (Transmission Control Protocol/Internet Protocol) is used as an upper communication protocol, for example.

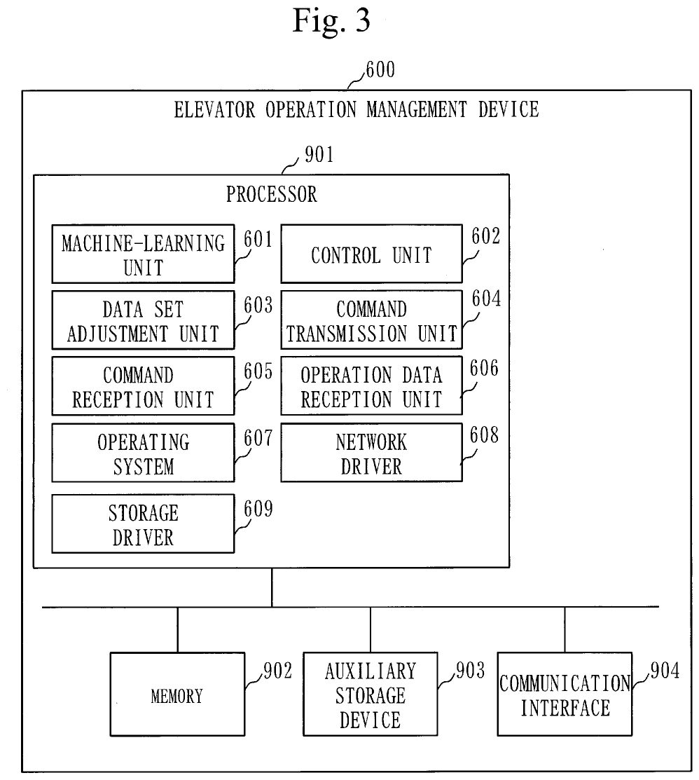

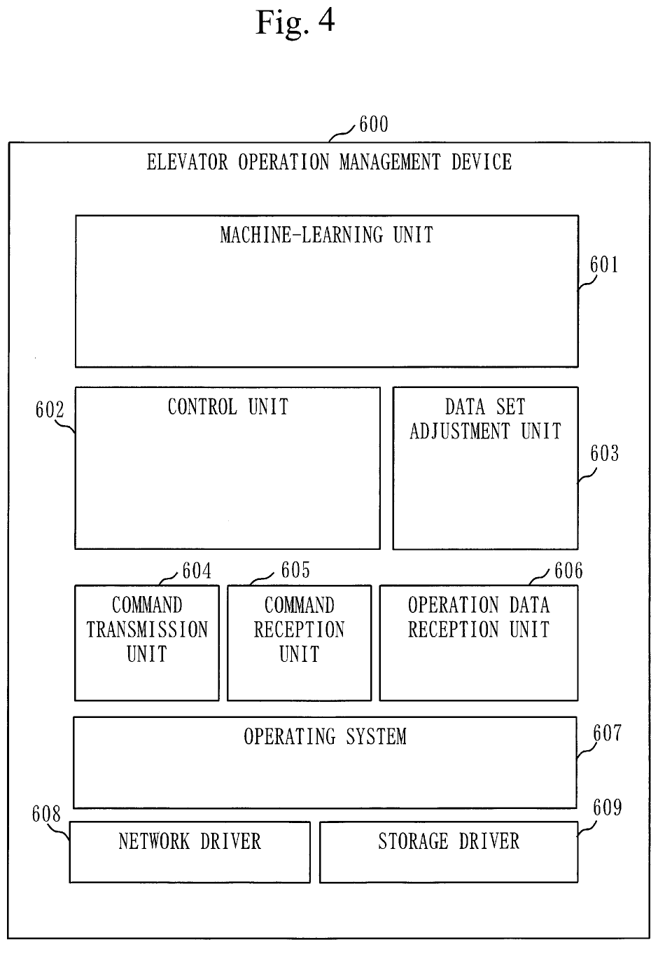

FIG. 3 illustrates a hardware configuration example of the elevator operation management device 600. FIG. 4 illustrates a functional configuration example of the elevator operation management device 600.

Firstly, a hardware configuration of the elevator operation management device 600 is described with reference to FIG. 3.

The elevator operation management device 600 include a processor 901, a memory 902, an auxiliary storage device 903 and a communication interface 904 as hardware.

In the auxiliary storage device 903, programs for realizing functions of a machine-learning unit 601, a control unit 602, a data set adjustment unit 603, a command transmission unit 604, a command reception unit 605, an operation data reception unit 606, an operating system 607, a network driver 608 and a storage driver 609 illustrated in FIG. 4 are stored.

Then, these programs are loaded from the auxiliary storage device 903 to the memory 903. Next, the processor 901 reads out these programs from the memory 902, and executes these programs. Consequently, the processor 901 performs operation of the machine-learning unit 601, the control unit 602, the data set adjustment unit 603, the command transmission unit 604, the command reception unit 605, the operation data reception unit 606, the operating system 607, the network driver 608 and the storage driver 609.

FIG. 3 schematically illustrates a state in which the processor 901 executes the programs for realizing the functions of the machine-learning unit 601, the control unit 602, the data set adjustment unit 603, the command transmission unit 604, the command reception unit 605, the operation data reception unit 606, the operating system 607, the network driver 608 and the storage driver 609. At least the programs for realizing the functions of the machine-learning unit 601 and the control unit 602 correspond to an elevator operation management program.

The communication interface 904 performs communication with the display board 506, the destination button 507, the control panel 508, the communication device 509 and the wireless LAN access point 510 via the network switch 511.

Next, a functional configuration of the elevator operation management device 600 is described with reference to FIG. 4.

The machine-learning unit 601 performs machine-learning using operation data which indicates an operation status of the plurality of elevator cars, and generates an operation management algorithm being an algorithm used for operation management of the plurality of elevator cars.

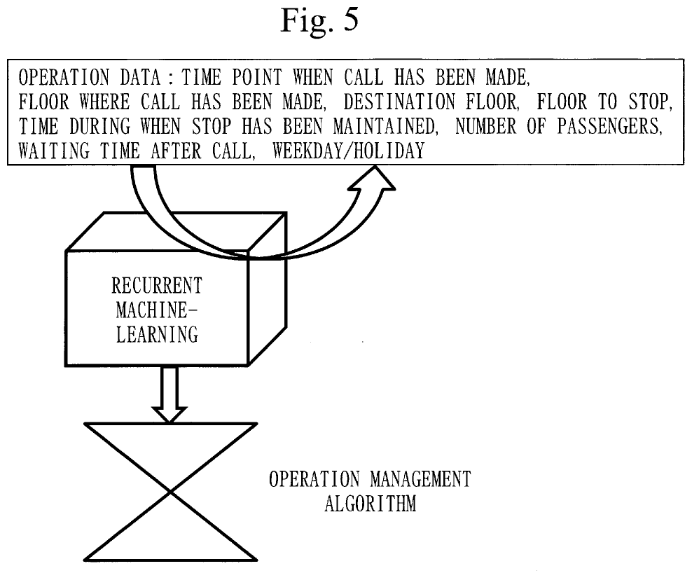

The machine-learning unit 601 performs recurrent machine-learning as illustrated in FIG. 5, and generates as the operation management algorithm, an algorithm for selecting an elevator car with the shortest waiting time out of the plurality of elevator cars when a call has been made.

As exemplified in FIG. 5, operation data includes information on a time point when a call has been made, a floor where a call has been made, a destination floor, a floor to stop, time during when a stop has been maintained, the number of passengers, waiting time after a call, and whether a day when an elevator has been operated is a weekday or a holiday.

Also, the machine-learning unit 601, at the timing for updating the operation management algorithm, performs machine-learning using operation data which has been accumulated until the timing for updating, and updates the operation management algorithm.

Operation performed by the machine-learning unit 601 corresponds to a machine-learning process.

The control unit 602 executes the operation management algorithm generated by the machine-learning unit 601, and performs operation management of the plurality of elevator cars.

More specifically, the control unit 602 executes the operation management algorithm when a call has been made, and selects an elevator car with the shortest waiting time out of the plurality of elevator cars. Then, the control unit 602 causes the selected elevator car to move to the floor where the call has been made.

After the machine-learning unit 601 updates the operation management algorithm, the control unit 602 executes the updated operation management algorithm, and performs operation management of the plurality of elevator cars.

Operation performed by the control unit 602 corresponds to a control process.

The data set adjustment unit 603 provides the machine-learning unit 601 with a learning data set used for machine-learning. The learning data set includes operation data from the control panel 508 and various kinds of commands.

The command transmission unit 604 transmits a command from the control unit 602 to the control panel 508.

The command reception unit 605 receives a call from an elevator user.

Also, the command reception unit 605 receives a command from the control panel 508 when an abnormality occurs in an elevator system or when any of the elements in the elevator system is broken.

The operation data reception unit 606 receives operation data described above from the control panel 508.

The operation data reception unit 606 stores the received operation data in the auxiliary storage device 903, using the storage driver 609.

The operating system 607 manages the machine-learning unit 601, the control unit 602, the data set adjustment unit 603, the command transmission unit 604, the command reception unit 605 and the operation data reception unit 606 which are application programs.

Also, the operating system 607 performs task management, memory management, file management and communication control.

The network driver 608 is a device driver for controlling the communication interface 904.

The storage driver 609 is a device driver for controlling the auxiliary storage device 903.

***Description of Operation***

Next, an operational outline of the elevator operation management device 600 according to the present embodiment will be described.

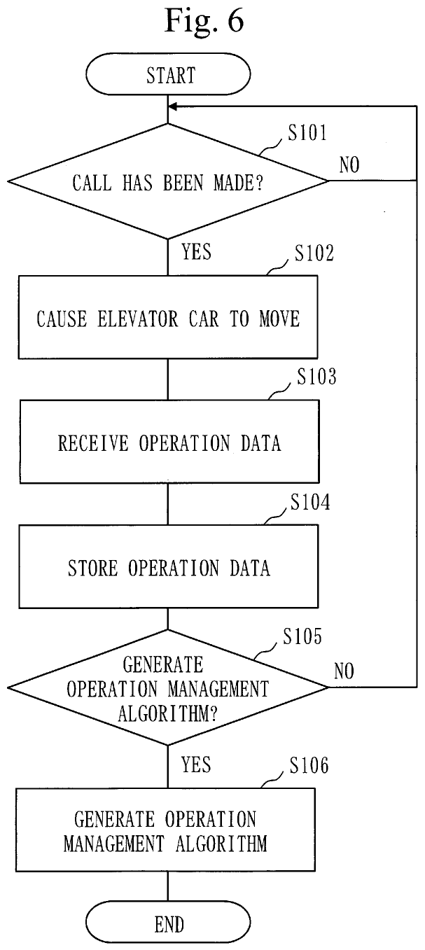

FIG. 6 illustrates the operational outline of the elevator operation management device 600 according to the present embodiment.

In FIG. 6, when a call for an elevator car has been made (YES in step S101), the control unit 602 causes an elevator car to move to the floor where the call has been made (step S102). That is, the control unit 602 selects an elevator car which can arrive at the floor where the call has been made with the shortest waiting time. Then, the control unit 602 causes the selected elevator car to move to the floor where the call has been made.

Next, the operation data reception unit 606 receives operation data which indicates the operation status of step S102 from the control panel 508 (step S103).

The operation data reception unit 606 stores the received operation data in the auxiliary storage device 902 (step S104).

In the elevator operation management device 600, every time a call for an elevator car is made by an elevator user, the above procedure of FIG. 5 is performed, and operation data is accumulated in the auxiliary storage device 902.

Then, when a timing for generating an operation management algorithm comes (YES in step S105), the machine-learning unit 601 generates an operation management algorithm by machine-learning (step S106).

Thus, operation data is accumulated in the auxiliary storage device 902 every time a call is made until the operation management algorithm is generated by the machine-learning unit 601. For this reason, operation data stored in the auxiliary storage device 902 increases as time passes.

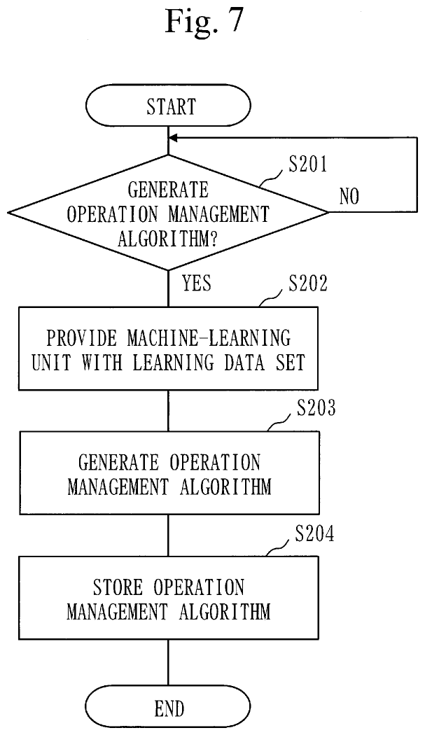

Next, a procedure for generating the operation management algorithm by machine-learning will be described with reference to FIG. 7. FIG. 7 illustrates the procedure for generating the operation management algorithm. FIG. 7 illustrates details of step S105 and step S105.

Firstly, the control unit 602 determines whether the timing for generating the operation management algorithm has come or not (step S201).

A timing for performing machine-learning may be a fixed timing, or may be a timing when an event occurs.

As the fixed timing, for example, machine-learning may be performed every month. Also, machine-learning may be performed in a cycle other than a month (a week, for example).

For the timing when an event occurs, for example, machine-learning may be performed when a tenant of a building is changed.

Also, in the initial machine-learning, a manager of the elevator operation management device 600 may instruct the control unit 602 to perform machine-learning.

Next, the data set adjustment unit 603 provides the machine-learning unit 601 with a learning data set (step S202).

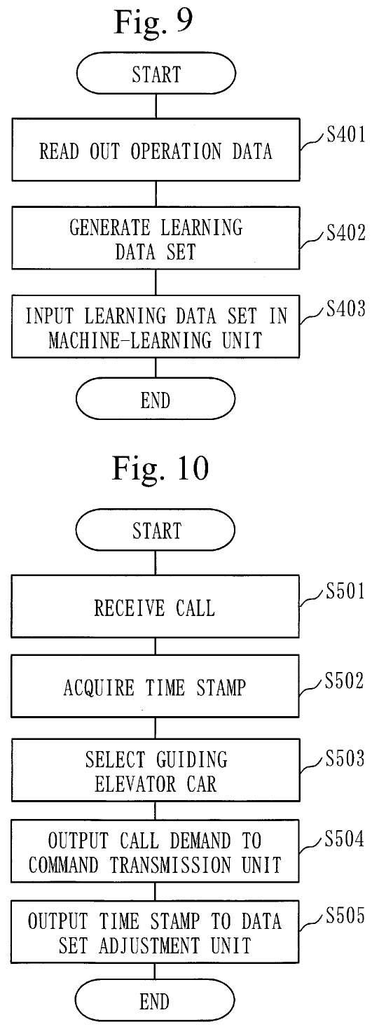

More specifically, as illustrated in FIG. 9, the data set adjustment unit 603 reads out operation data from the auxiliary storage device 902 (step S401). Also, the data set adjustment unit 603 generates a learning data set, adding a command necessary for machine-learning to the operation data (step S402). Then, the data set adjustment unit 603 inputs the generated learning data set in the machine-learning unit 601 (step S403).

Next, the machine-learning unit 601 performs machine-learning using the learning data set, and generates an operation management algorithm (step S203).

Details of machine-learning will be described later.

Finally, the machine-learning unit 601 stores the generated operation management algorithm in the auxiliary storage device 903 (step S204).

From the above, the machine-learning unit 601 can generate the operation management algorithm which matches the actual state by machine-learning using operation data which indicates an operation status of the plurality of elevator cars.

Next, details of step S203 in FIG. 7 will be described.

When the machine-learning unit 601 acquires the learning data set (called as a learning data set θ hereinafter), it performs machine-learning as below, and generates an operation management algorithm which is the most appropriate elevator control logic. In the following, it is assumed that a data type included in the learning data set θ is n. Also, n is a vector of x⁽ⁱ⁾. Also, i indicates the orders in n. Therefore, if a label, that is an evaluation formula, is assumed to be h_{θ}, hθ(x) is expressed in the following manner.

h_{θ}(x)=θ₀x₀+θ₁x₁+ . . . θₙxₙ

Here, θ₀x₀ is assumed to be 1 for convenience of probability calculation.

Note that x and θ are assumed as below.

$$x = [ \begin{matrix}{x}_{0} \\ {x}_{1} \\ ⋮ \\ {x}_{n}\end{matrix} ] ∈ {ℝ}^{n + 1} , θ = [ \begin{matrix}{θ}_{0} \\ {θ}_{1} \\ ⋮ \\ {θ}_{n}\end{matrix} ] ∈ {ℝ}^{n + 1} \qquad [ Formula 1 ]$$

When x and θ are assumed as above, h_{θ}(x) is expressed in the following manner.

h_{θ}(x)=θ^{T}x

On every call for an elevator car, when J(θ) is assumed to be a cost function, and y⁽ⁱ⁾ is assumed to be arrival time possible to be shortened, J(θ) is expressed in the following manner.

$$J ( θ ) = \frac{1}{2 m} {\sum }_{i = 1}^{m} {( {h}_{θ} ( {x}^{i} ) - {y}^{i} )}^{2} \qquad [ Formula 2 ]$$

If the above formula is expressed in an algorithm, the following is acquired.

$$while not converged \{ \\ for all j \\ {tmp}_{j} := {θ}_{j} - α \frac{\partial }{\partial {θ}_{j}} J ( θ ) \\ θ := [ \begin{matrix}{tmp}_{0} \\ ⋮ \\ {tmp}_{n}\end{matrix} ] \\ \} \\ \} \qquad [ Formula 3 ]$$

In the above formula, “:=” means substitution. Also, α is a monotonously decreasing coefficient.

However, the machine-learning unit 601 adjusts all variables so that all variables become −1≤x≤1, in order to equalize variable weights.

When J(θ) is plotted for each data set, the cost function J(θ) may be considered to be functioning correctly if J(θ) decreases monotonously as J increases.

Thus, the machine-learning unit 601 can generate an operation management algorithm for accurately predicting time from a call for an elevator car to arrival of the elevator car, by continuously providing the machine-learning unit 601 with the learning data set.

The machine-learning unit 601 stores the operation management algorithm in the auxiliary storage device 902 at a phase when the cost function J(θ) reaches a target value, or the like. If the operation management algorithm has already been stored in the auxiliary storage device 902, the machine-learning unit 601 stores an updated operation management algorithm in place of the operation management algorithm before updating which has been already stored in the auxiliary storage device 902, at the phase when the cost function J(θ) reaches the target value, or the like.

In machine-learning, it is not desirable to excessively pursue an algorithm which matches all sets of learning data (operation data) in order to acquire the best algorithm in the end. Therefore, it is common to acquire an algorithm, using an index called a cost function.

Also in the above, the operation management algorithm is stored in the auxiliary storage device 902 at the phase when the cost function reaches at the target value, or the like.

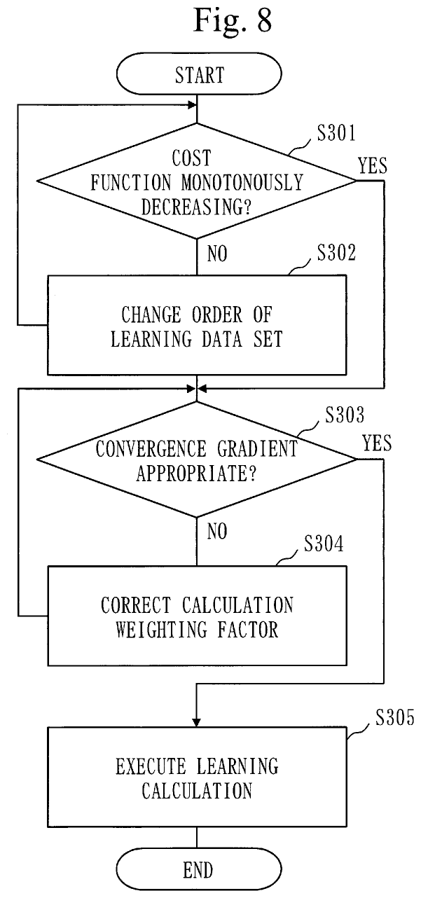

The machine-learning unit 601 operates in the operation procedure illustrated in FIG. 8, for example.

Specifically, the machine-learning unit 601 repeatedly evaluates a data set with a cost function consisting of parameter discreteness in a learning data set dimension, and verifies whether the cost function decreases monotonously or not (step S301).

When the cost function does not decrease monotonously (NO in step S301), the machine-learning unit 601 instructs the data set adjustment unit 603 to change the order of learning data sets, and the data set adjustment unit 603 changes the order for inputting learning data sets to the machine-learning unit 601 (step S302).

In the present embodiment, as illustrated in FIG. 5, the learning data set dimension is 8 ((1) a time point when a call has been made, (2) a floor where a call has been made, (3) a destination floor, (4) a floor to stop, (5) time during when a stop has been maintained, (6) the number of passengers, (7) waiting time after a call, (8) weekday/holiday), for example. In this case, the cost function always decreases monotonously. However, even when the cost function decreases monotonously, the machine-learning unit 601 may change the order of learning data sets for efficiently decreasing the cost function.

It is desirable that a convergence gradient becomes gentle against the total number of learning data sets. The machine-learning unit 601 determines if the convergence gradient is appropriate or not, from the number of learning data sets and its discreteness (step S303). Then, if the convergence gradient is not appropriate (NO in step S303), the machine-learning unit 601 corrects a calculation weighting factor for a new learning data set (step S304).

The machine-learning unit 601 performs machine-learning, and generates an operation management algorithm while performing above adjustments (step S305).

The machine-learning unit 601 may perform the above adjustments not only at a timing for providing the control unit 602 with the operation management algorithm but also when necessary.

FIG. 10 illustrates an overall operation procedure of the control unit 602.

The control unit 602 receives a call from an elevator user via the command reception unit 605 (step S501).

Next, the control unit 602 acquires a time stamp of a time point when a call has been made, using an NTP (Network Time Protocol), for example (step S502).

Next, the control unit 602 executes the operation management algorithm which the machine-learning unit 601 has generated by performing machine-learning, and selects a guiding elevator car to which the elevator user is guided (step S503).

Next, the control unit 602 outputs a call request for the guiding elevator car to the command transmission unit 604 (step S504). The command transmission unit 604 transmits the call request to the control panel 508 of the guiding elevator car.

Finally, the control unit 602 outputs the time stamp acquired in step S502 to the data set adjustment unit 603 (step S505). The data set adjustment unit 603 includes the time stamp in operation data as a time point when a call has been made.

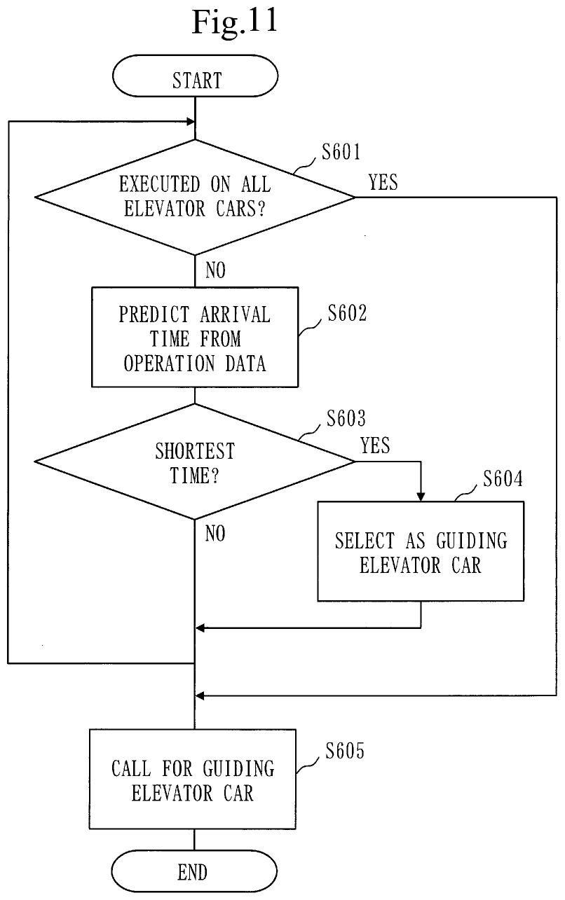

Next, details of step S503 will be described with reference to FIG. 11.

The control unit 602 determines if the processes of step S602 and after have been executed to all elevator cars (step S601).

If there exists an elevator car to which the processes of step S602 and after have not been executed (NO in step S601), the control unit 602 performs a process of step S602.

Specifically, the control unit 602 executes the operation management algorithm generated by the machine-learning unit 601, and predicts arrival time until the elevator car arrives at the floor where the call has been made, from operation data (step S602).

Next, the control unit 602 determines if the arrival time predicted in step S602 is the shortest of predicted arrival time (step S603).

If the arrival time predicted in step S602 is the shortest time (YES in step S603), the control unit 602 selects the elevator car as the guiding elevator car. If there exists an elevator car already selected as the guiding elevator car, the control unit 602 invalidates the existing guiding elevator car, and validates only the newly selected guiding elevator car.

Then, when the control unit 602 executes the processes of step S602 and after to all elevator cars (YES in step S601), it makes a call for the selected guiding elevator car (step S605).

Also, the control unit 602 may display waiting time on a display device installed on the floor where a call has been made, using the arrival time predicted in step S602.

By doing this, the elevator user can be aware of waiting time quickly and dynamically, and can realize improvement of convenience.

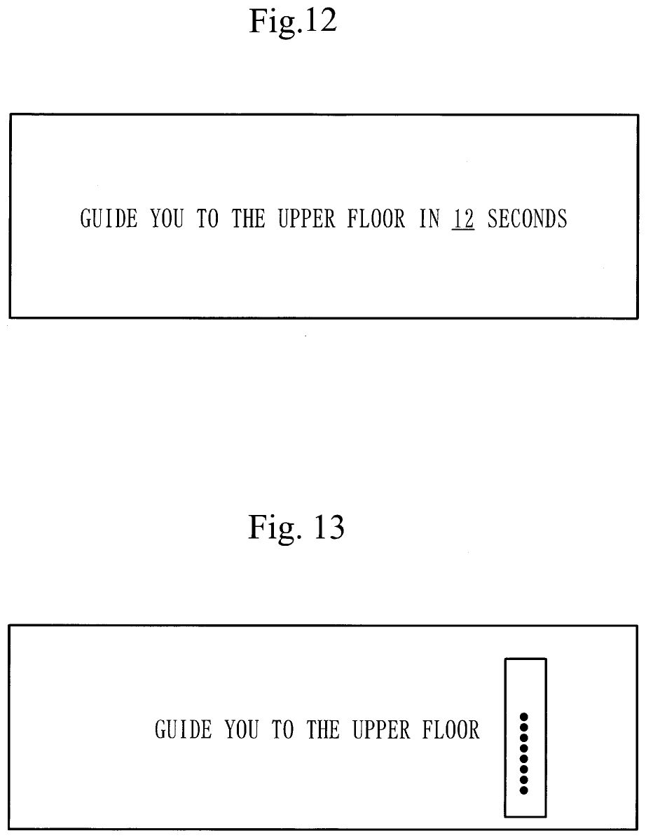

The control unit 602, for example, displays waiting time on a display device in a countdown form as illustrated in FIG. 12. Also, the control unit 602, for example, may display waiting time on a display device in a sandglass form as illustrated in FIG. 13.

### ***Description of Effect of Embodiment***

Thus, in the present embodiment, an operation management algorithm is generated by machine-learning using operation data which indicates an operation status of a plurality of elevator cars. Then, the generated operation management algorithm is executed, and operation management of the plurality of elevator cars is performed.

Therefore, according to the present embodiment, operation management of elevator cars can be performed appropriately by the operation management algorithm which matches the actual operation status.

Especially, even when a change in a flow of people occurs due to a change in a tenant of a building, appropriate operation management matching a new flow of people can be performed, according to the present embodiment.

Note that the operation management algorithm output by the machine-learning unit 601 is complicated and large-scale. As the number of dimensions in one learning data set increases, it is very difficult for people to understand the operation management algorithm.

Operation data may not be changed arbitrarily, even when an elevator car stops operation due to a failure or maintenance, or even when the elevator car cannot move because people and goods remain in the elevator car on an occasion of moving to a forwarding hoist lane described in Embodiment 2.

In addition, mechanisms that ensure a fail-safe in an elevator system need to be secured by closing them below a control panel as before.

It is desirable to confirm presence of people and goods by image recognition using a neural network.

### Embodiment 2

In the present embodiment, an example will be described, in which an elevator operation management device 600 performs operation management of a plurality of elevator cars in a building where a regular hoist lane and a forwarding hoist lane are provided.

The regular hoist lane is a lane where elevator cars go up and down in a hoistway so that people and goods can get on and off. The forwarding hoist lane is a lane where elevator cars go up and down for forwarding operation.

In the present embodiment, mainly a difference from Embodiment 1 will be described.

Note that items which are not described in the present embodiment are the same as Embodiment 1.

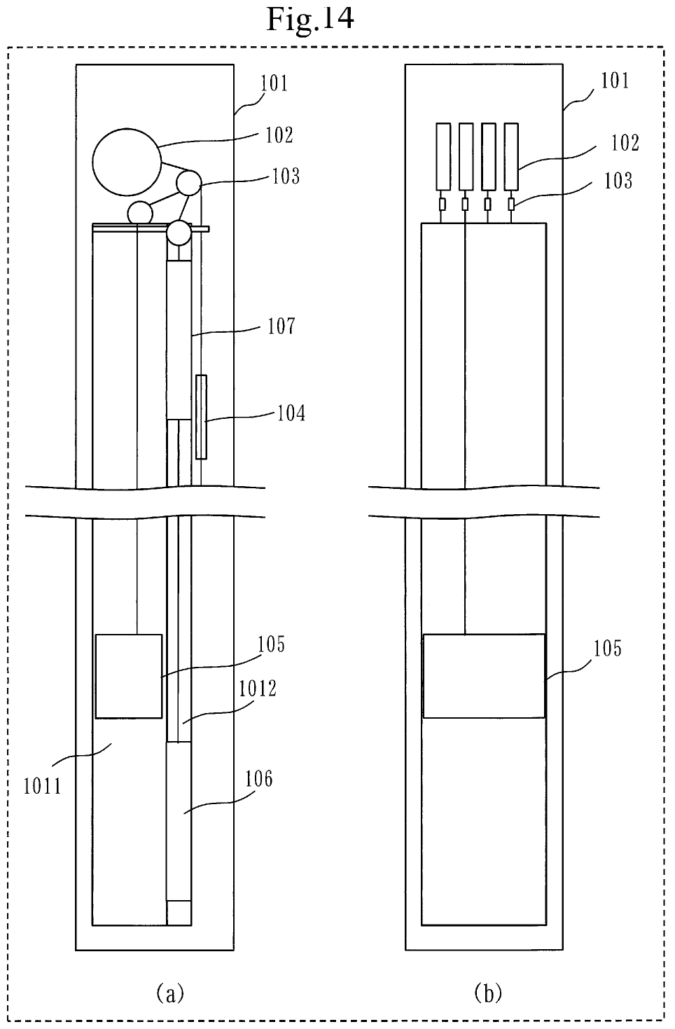

FIG. 14 illustrates an example of a hoistway according to the present embodiment.

FIG. 14 illustrates an example of a hoistway in which an elevator car equipped with a machine room goes up and down. However, the hoistway according to the present embodiment can be applied to going up and down of an elevator car without a machine room.

Note that mechanisms required for designing an actual hoistway are the same as before, so descriptions of these mechanisms are omitted. Specifically, descriptions of a speed regulator, a control cable, a compensation chain, a landing sill, a toe guard, a limit switch, a final limit switch, a straining pulley, doors of an elevator car, a safety shoe, a car sill, a door control device, safeties, a guide shoe and so forth are omitted.

(a) of FIG. 14 indicates the side of the hoistway. (b) of FIG. 14 indicates the front of the hoistway.

In a hoistway 101, a regular hoist lane 1011 and a forwarding hoist lane 1012 are provided.

In the regular hoist lane 1011, an elevator car 105 goes up and down in a regular state. That is, the elevator car 105 in the regular state is in a state capable of carrying people and goods. On the other hand, in the forwarding hoist lane 1012, an elevator car 106 and an elevator car 107 go up and down in a folded state. That is, the elevator car 106 and the elevator car 107 in a folded state are not in a state capable of carrying people and goods.

As there are 4 sets of a hoisting machine 102 and a pulley 103 in (b) of FIG. 14, there exist 4 elevator cars in the hoistway 101. In (a) of FIG. 14, only 2 elevator cars of the elevator car 106 and the elevator car 107 are illustrated in the forwarding hoist lane 1012 for convenience of drawing, however, there exist 3 elevator cars in the forwarding hoist lane 1012.

The elevator car 105 in the regular hoist lane 1011 retreats at an arbitrary position (floor), enters the forwarding hoist lane 1012, and becomes folded to be the elevator car 106 or the elevator car 107. On the other hand, the elevator car 106 or the elevator car 107 in the forwarding hoist lane 1012 moves forward at an arbitrary position (floor), enters the regular hoist lane 1011, and becomes unfolded to be the elevator car 105. That is, the elevator car 105, and the elevator car 106 and the elevator car 107 can change lanes at an arbitrary position (floor).

Each of the elevator car 105, the elevator car 106 and the elevator car 107 are connected to the hoisting machine 102 via the pulley 103. The pulley 103 changes positions depending on when an elevator car is positioned in the regular hoist lane 1011 and when the elevator car is positioned in the forwarding hoist lane 1012. Also, the elevator car 105, the elevator car 106 and the elevator car 107 are equipped with a weight 104.

A guide rail is provided in each of the regular hoist lane and the forwarding hoist lane. The elevator car which has been folded and has moved to the forwarding hoist lane can move to the top floor if there is no elevator car above in the forwarding hoist lane. Likewise, the elevator car which has been folded and has moved to the forwarding hoist lane can move to the lowest floor if there is no elevator car below in the forwarding hoist lane.

Also, in the forwarding hoist lane, the folded elevator car can move at very high speed because there is no speed limit.

Next, a method of moving elevator cars between the regular hoist lane and the forwarding hoist lane will be described.

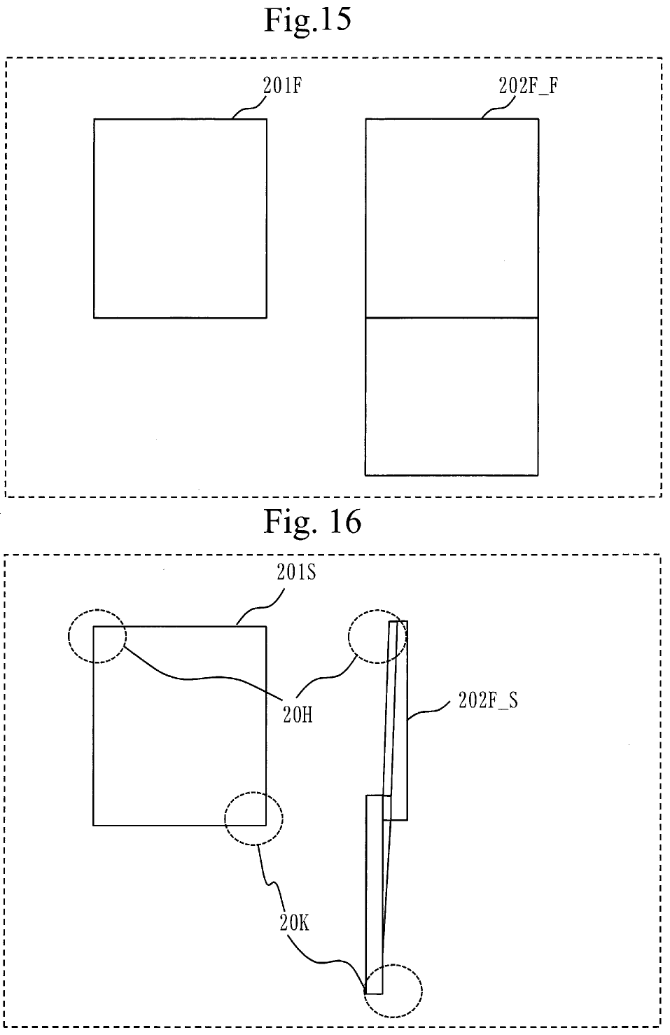

FIG. 15 illustrates an elevator car 201F in the regular hoist lane viewed from the front and an elevator car 202F_F in the forwarding hoist lane viewed from the front.

FIG. 16 illustrates the elevator car 201F in the regular hoist lane viewed from the side and the elevator car 202F_F in the forwarding hoist lane viewed from the side.

Folding an elevator car is realized by a hinge mechanism 20H. Also, moving an elevator car between the regular hoist lane and the forwarding hoist lane is realized by a latch 20K.

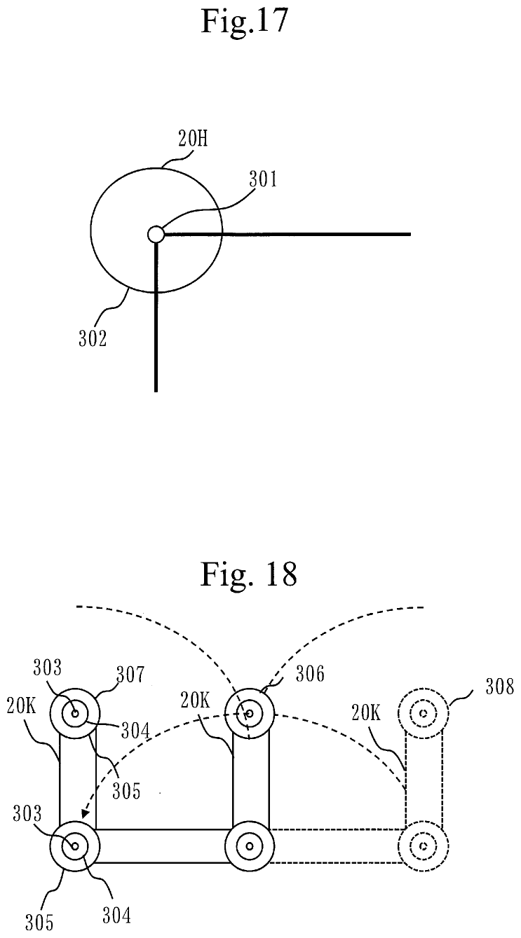

FIG. 17 illustrates details of the hinge mechanism 20H. FIG. 18 illustrates details of the latch 20K.

The hinge mechanism 20H is mounted at the upper front of an elevator car. The hinge mechanism 20H includes a hinge 301 and a stepping motor 302. The hinge 301 is controlled by the stepping motor 302 so that it becomes 90 degrees in the regular hoist lane, and 180 degrees in the forwarding hoist lane in principle. The hinge 301 is also mounted at the lower front, the upper rear and the lower rear of an elevator car. Depending on a capacity of the stepping motor 302, the stepping motor 302 may be provided in other hinges 301 as well.

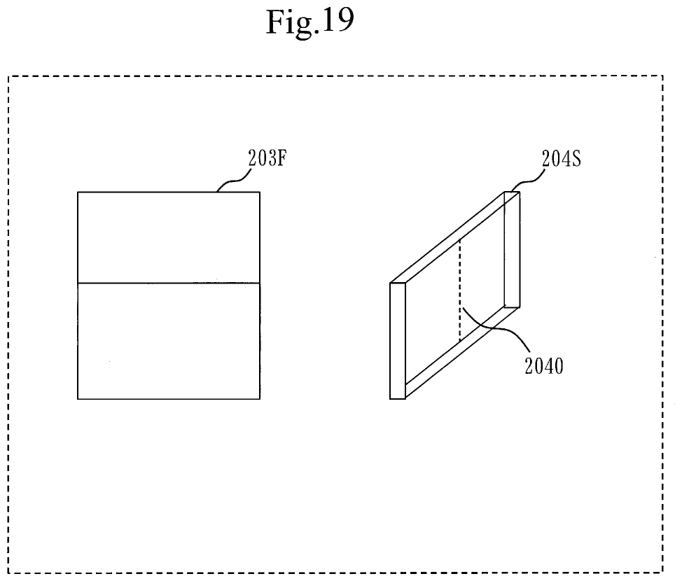

FIG. 19 illustrates an intermediate process of when an elevator car is folded. More specifically, a reference sign 203F and a reference sign 204S indicate an intermediate process of an elevator car being folded at a folding line 2040.

The latch 20K in FIG. 18 is provided with a guide rail induction end 303 at both ends, a wheel 304 which rotates in contact with the guide rail, and a stepping motor 305. State 306 is a state in which the latch 20K is on the guide rail of the forwarding hoist lane. The other latch 20K is also on the guide rail of the forwarding hoist lane. By rotating the stepping motor 305 by 90 degrees, the latch 20K gets on the regular hoist lane (state 307 or state 308). Also, as in state 307, if the stepping motor 305 rotates by 90 degrees in a state in which the latch 20K is on the guide rail of the regular hoist lane, the latch 20K gets on the guiderail of the forwarding hoist lane (state 306). As the latch 20H moves, the pulley 103 also moves between the regular hoist lane and the forwarding hoist lane.

Note that the present embodiment does not exclude a type of elevator in which a car moves on its own.

A functional configuration example and a hardware configuration example of the 60 according to the present embodiment are as described in Embodiment 1.

That is, also in the present embodiment, the machine-learning unit 601 preforms machine-learning, and generates an operation management algorithm as described in Embodiment 1.

In addition, also in the present embodiment, the control unit 602 executes the operation management algorithm as described in Embodiment 1, and manages operation of the elevator cars as described with reference to FIG. 14-FIG. 19.

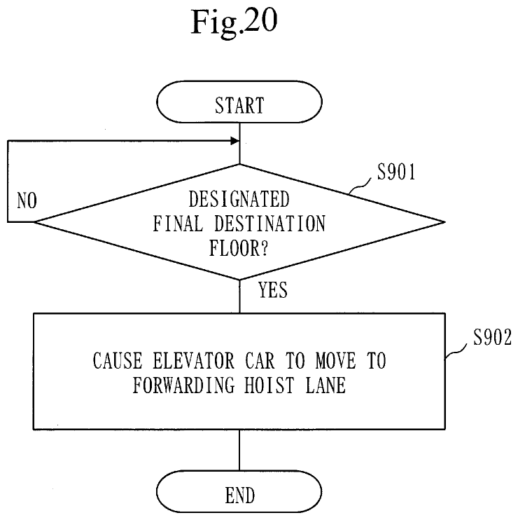

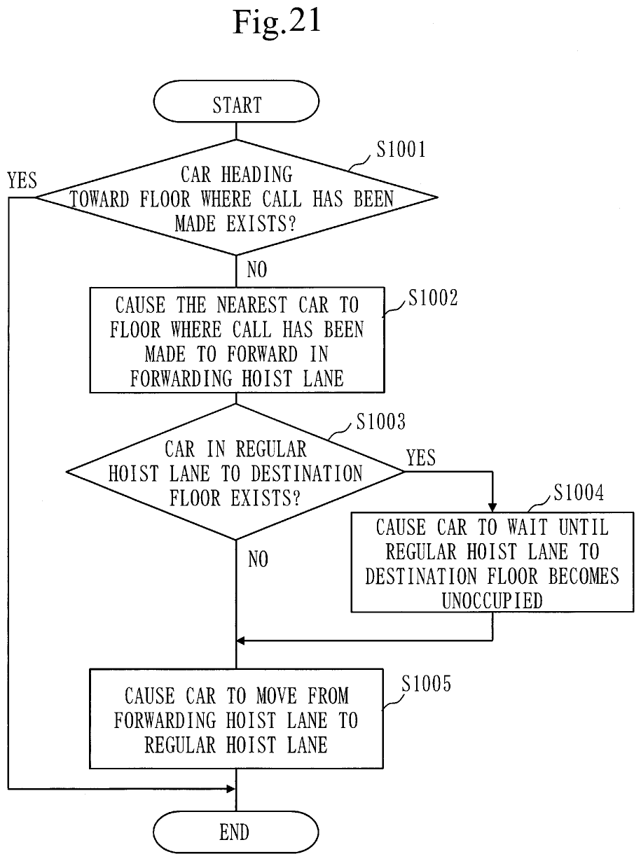

FIG. 20 and FIG. 21 illustrate an operation procedure of the control unit 602 according to the present embodiment.

FIG. 20 illustrates an operation procedure when the control unit 602 causes an elevator car to move from the hoist lane to the forwarding hoist lane.

FIG. 21 illustrates an operation procedure when the control unit 602 causes an elevator car to move from the hoist lane to the forwarding hoist lane.

In FIG. 20, when the elevator car in the regular hoist lane reaches at a designated final destination floor (step S901), the control unit 602 causes the elevator car to move to the forwarding hoist lane (step S902). In a case where there is another elevator car in the forwarding hoist lane on a destination floor when an elevator car reaches at the floor, the elevator car in the forwarding hoist lane moves to a floor where the elevator car can move horizontally, and moves horizontally at the floor. By doing this, the elevator car which reaches at the destination floor can move to the forwarding hoist lane.

In FIG. 21, if there is already an elevator car heading towards a floor where a call has been made when an elevator user has made a call (YES in step S1001), the control unit 602 ends operation.

On the other hand, if there is no elevator car heading towards the floor where a call has been made (NO in step S1001), the control unit 602 designates an elevator car in the forwarding hoist lane closest to the floor where a call has been made as a guiding elevator car, and causes the designated guiding elevator car to head forwards the floor where the call has been made (step S1002).

In a case where the guiding elevator cannot reach at the floor where the call has been made because of another elevator car existing in the regular hoist lane (YES in step S1003), the control unit 602 causes the guiding elevator car to wait until the regular hoist lane becomes free (step S1004). When the regular hoist lane to the destination floor becomes unoccupied, the control unit 602 causes the guiding elevator car to move from the forwarding hoist lane to the regular hoist lane (step S1005).

The following case can be considered, for example, as a case of YES in step S1003.

When an elevator user calls for an elevator car going upwards at the 10th floor, the control unit 602 causes an elevator car in the forwarding hoist lane at the 7th floor to head toward the 10th floor where the call has been made as a guiding elevator car. However, there exists an elevator car going downwards in the regular hoist lane at the 9th floor. In this case, the guiding elevator car cannot head towards the 10th floor because of the other elevator car going downwards in the regular hoist lane. Therefore, the control unit 602 causes the guiding elevator car to wait until the other elevator car passes the 7th floor.

Thus, according to the present embodiment, even in a building in which the regular hoist lane and the forwarding hoist lane exist in a hoistway, appropriate operation management can be performed by the operation management algorithm which matches the actual operation status.

### Embodiment 3

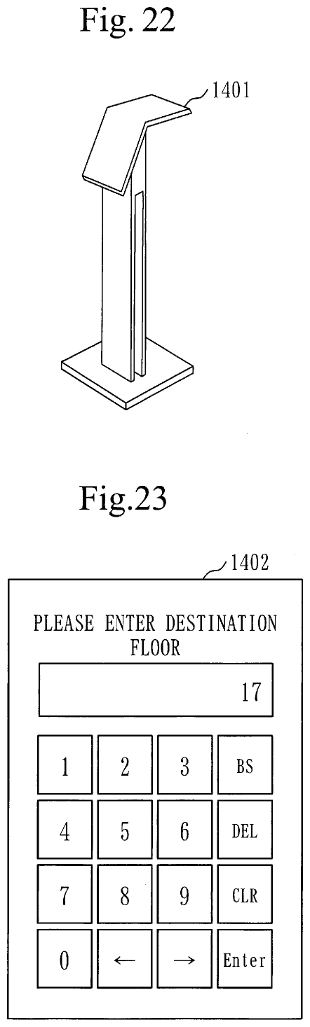

In the present embodiment, a configuration for further improving convenience of elevator users will be described. In the present embodiment, an elevator user can call an elevator car without pressing a call button normally installed on a wall of an elevator hall, but by a control panel installed on a hallway illustrated in FIG. 22.

The control panel 1401 is connected to the communication device 509 illustrated in FIG. 1 by a specified low power radio, but the function is the same as the conventional call button.

FIG. 23 illustrates an operation screen 1402 of the control panel 1401.

In an example of FIG. 23, a destination floor is input by a ten-key, but it is also acceptable that a destination floor is input by up-down buttons. Also, it is acceptable that a destination floor is input by destination floor buttons. Also, in a high-rise building, it is acceptable that destination floor buttons are scrolled by swipe operation.

### Embodiment 4

A penetration rate of smartphones in Japan has exceeded 50%. Smartphones enable not only communication by a mobile communication network, but also communication by a wireless LAN and Bluetooth (registered trademark). If an elevator call using the wireless LAN is enabled, it is possible to provide a service optimized for an individual elevator user.

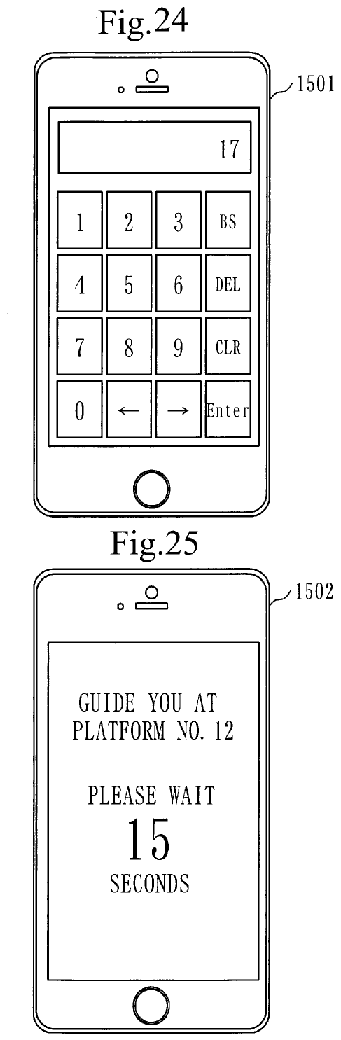

FIG. 24 illustrates an example of an input screen 1501 of a destination floor displayed on a smartphone. Also, FIG. 25 illustrates an example of a notification screen of waiting time displayed on the smartphone.

Thus, in the present embodiment, the control unit 602 of the elevator operation management device 600 can accept a registration of a destination floor from the smartphone which is a mobile terminal device of the elevator user. Also, in the present embodiment, the control unit 602 of the elevator operation management device 600 can display a predicted waiting time on the smartphone of the elevator user who has made a call. In an example of FIG. 25, waiting time is displayed in a countdown form, but it may be displayed in a sandglass form as illustrated in FIG. 13.

Thus, in the present embodiment, communication is performed between the elevator operation management device 600 and the smartphone of the elevator user, but there is a security problem if an unknown elevator user is allowed to freely access to the elevator operation management device 600. Therefore, a MAC (Media Access Control) address of the smartphone of the elevator user is registered in an RADIUS (Remote Authentication Dial-in User Service) server (IEEE 802.1x) in advance. When the smartphone of the elevator user accesses the elevator operation management device 600, the control unit 602 provides the smartphone with an IP address fixedly on the condition that the RADIUS server can authenticate the smartphone. After that, a registration of a destination floor and a notification of waiting time are performed between the control unit 602 and the smartphone, using the IP address provided to the smartphone by the control unit 602. The RADIUS server is a well-known technology, so description is omitted.

Since the destination floor is usually the same when going for work or the like, it is possible to perform operation of making an elevator call automatically when the smartphone of the elevator user enters a communication area of a wireless LAN access point.

The embodiments of the present invention are described above, but of these embodiments, two or more embodiments may be practiced by a combination.

Alternatively, one embodiment out of these embodiments may be practiced partially.

Alternatively, two or more embodiments out of these embodiments may be practiced by a partial combination.

The present invention is not restricted to these embodiments, and various modifications can be made as necessary.

***Description of Hardware Configuration***

Finally, supplemental description of hardware configuration of the elevator operation management device 600 will be made.

The processor 901 illustrated in FIG. 3 is an IC (Integrated Circuit) which performs processing.

The processor 901 is a CPU(Central Processing Unit), a DSP(Digital Signal Processor), or the like.

The memory 902 illustrated in FIG. 3 is a RAM (Random Access Memory).

The auxiliary storage device 903 illustrated in FIG. 3 is a ROM (Read Only Memory), a flash memory, an HDD (Hard Disk Drive), or the like.

The communication device 904 illustrated in FIG. 3 includes a receiver for receiving data and a transmitter for transmitting data.

The communication interface 904 is a communication chip or an NIC (Network Interface Card), for example.

Also, information, data, a signal value and a variable value indicating the results of processes of the machine-learning unit 601, the control unit 602, the data set adjustment unit 603, the command transmission unit 604, the command reception unit 605, the operation data reception unit 606, the operating system 607, the network driver 608 and the storage driver 609 are stored in at least any of the memory 902, the auxiliary storage device 903, a register and a cache memory in the processor 901.

Also, programs for realizing the functions of the machine-learning unit 601, the control unit 602, the data set adjustment unit 603, the command transmission unit 604, the command reception unit 605, the operation data reception unit 606, the operating system 607, the network driver 608 and the storage driver 609 may be stored in a portable storage medium such as a magnetic disk, a flexible disk, an optical disk, a compact disk, a Blu-ray (registered trademark) disk, or a DVD.

Also, the “units” in the machine-learning unit 601, the control unit 602, the data set adjustment unit 603, the command transmission unit 604, the command reception unit 605 and the operation data reception unit 606 may be read as “circuits”, “steps”, “procedures”, or “processes”.

Also, the elevator operation management device 600 may be realized by an processing circuit such as a logic IC (Integrated Circuit), a GA (Gate Array), an ASIC (Application Specific Integrated Circuit), or an FPGA (Field-Programmable Gate Array).

In this specification, a broader concept of the processor, the memory, the combination of processor and memory, and the processing circuits is referred to as “processing circuitry”.

That is, the processor, the memory, the combination of processor and memory, and the processing circuits are specific examples of “processing circuitry”.

### REFERENCE SIGNS LIST

100: elevator car, 101: hoistway, 102: hoisting machine, 103: pulley, 104: weight, 105: elevator car, 106: elevator car, 107: elevator car, 1011: regular hoist lane, 1012: forwarding hoist lane, 506: display board, 507: destination button, 508: control panel, 509: communication device, 510: wireless LAN access point, 511: network switch, 600: elevator operation management device, 601: machine-learning unit, 602: control unit, 603: data set adjustment unit, 604: command transmission unit, 605: command reception unit, 606: operation data reception unit, 607: operating system, 608: network driver, 609: storage driver.

1. An elevator operation management device performing operation management of a plurality of elevator cars, the elevator operation management device comprising:
processing circuitry:
to perform machine-learning using operation data which indicates an operation status of the plurality of elevator cars, and generate an operation management algorithm which is an algorithm used for operation management of the plurality of elevator cars; and
to perform operation management of the plurality of elevator cars by executing the generated operation management algorithm, in a building where a regular hoist lane and a forwarding hoist lane are provided, and the elevator cars goes up and down in the forwarding hoist lane in a folded state, the regular hoist lane being a lane where the elevator cars go up and down in a hoistway so that people and goods can get on and off, the forwarding hoist lane being a lane where the elevator cars go up and down for forwarding operation.

2. The elevator operation management device according to claim 1,
wherein the processing circuitry, at a timing for updating the operation management algorithm, performs machine-learning using operation data which has been accumulated until the timing for updating, and updates the operation management algorithm; and
wherein the processing circuitry performs operation management of the plurality of elevator cars, executing an updated operation management algorithm, after the operation management algorithm is updated.

3. The elevator operation management device according to claim 1,
wherein the processing circuitry performs machine-learning using operation data including information at least on a time point when a call has been made, a floor where a call has been made, a destination floor, a floor to stop, time during when a stop has been maintained, the number of passengers, waiting time after a call, and whether a day when an elevator has been operated is a weekday or a holiday.

4. The elevator operation management device according to claim 1,
wherein the processing circuitry performs machine-learning, and generates as the operation management algorithm, an algorithm for selecting an elevator car with the shortest waiting time when a call is made, out of the plurality of elevator cars; and
wherein the processing circuitry executes the operation management algorithm when a call has been made, and selects the elevator car with the shortest waiting time out of the plurality of elevator cars.

5. The elevator operation management device according to claim 4,
wherein the processing circuitry displays waiting time until the selected elevator car reaches at a floor where the call has been made on a display device placed at the floor where the call has been made.

6. The elevator operation management device according to claim 4,
wherein the processing circuitry displays waiting time until the selected elevator car reaches at a floor where the call has been made on a mobile terminal device of an elevator user who called an elevator.

7. The elevator operation management device according to claim 5,
wherein the processing circuitry displays the waiting time in at least either a countdown form or a sandglass form.

8. The elevator operation management device according to claim 1,
wherein the processing circuitry accepts a registration of a destination floor of an elevator user from the mobile terminal device of the elevator user.

9. (canceled)

10. (canceled)

11. The elevator operation management device according to claim 1,
wherein the processing circuitry performs operation management of the plurality of elevator cars in response to a call by a control panel placed in a hallway.

12. An elevator operation management method by an elevator operation management device performing operation management of the plurality of elevator cars, the elevator operation management method comprising:
performing machine-learning using operation data which indicates an operation status of a plurality of elevator cars, and generating an operation management algorithm which is an algorithm used for operation management of the plurality of elevator cars; and
performing operation management of the plurality of elevator cars by executing the generated operation management algorithm, in a building where a regular hoist lane and a forwarding hoist lane are provided, and the elevator cars goes up and down in the forwarding hoist lane in a folded state, the regular hoist lane being a lane where the elevator cars go up and down in a hoistway so that people and goods can get on and off, the forwarding hoist lane being a lane where the elevator cars go up and down for forwarding operation.

13. A non-transitory computer readable medium storing an elevator operation management program to cause an elevator operation management device performing operation management of a plurality of elevator cars to execute:
a machine-learning process of performing machine-learning using operation data which indicates an operation status of the plurality of elevator cars and generating an operation management algorithm which is an algorithm used for operation management of the plurality of elevator cars; and
a control process of performing operation management of the plurality of elevator cars by executing the operation management algorithm generated by the machine-learning process, in a building where a regular hoist lane and a forwarding hoist lane are provided, and the elevator cars goes up and down in the forwarding hoist lane in a folded state, the regular hoist lane being a lane where the elevator cars go up and down in a hoistway so that people and goods can get on and off, the forwarding hoist lane being a lane where the elevator cars go up and down for forwarding operation.

14. The elevator operation management device according to claim 6,
wherein the processing circuitry displays the waiting time in at least either a countdown form or a sandglass form.
